(19) United States
(12) Patent Application Publication
(10) Pub. No.: US 2025/0378018 A1
(43) Pub. Date: Dec. 11, 2025

(54) HOST-SIDE OPERATIONS ASSOCIATED WITH TAGGED CAPACITY OF A MEMORY DEVICE

(71) Applicant: MICRON TECHNOLOGY, INC., Boise, ID (US)

(72) Inventor: John M. Groves, Austin, TX (US)

(21) Appl. No.: 19/211,864

(22) Filed: May 19, 2025

Related U.S. Application Data
(60) Provisional application No. 63/657,212, filed on Jun. 7, 2024.

(51) Int. Cl. G06F 12/02

(52) U.S. Cl. CPC G06F 12/023; G06F 2212/1041

(57) ABSTRACT

A host system can include a memory and a processing device, operatively coupled with the memory. The processing device is configured to perform operations including sending, to a memory device, data to be stored in the memory device, wherein the memory device comprises a plurality of dynamic capacity devices, wherein the plurality of dynamic capacity devices comprises a plurality of memory sections; receiving, from the memory device, a response including tag information, wherein the tag information comprises a set of tags in an order, wherein each tag of the set of tags is associated with a respective memory section of the plurality of memory sections, and wherein the respective memory section stores a respective portion of the data; mapping the tags to logical addresses of the data; and accessing the data by aggregating, in the order of the set of tags, a plurality of device physical address (DPA) ranges, wherein each DPA range of the plurality of DPA ranges is associated with a respective tag of the tags.

### RELATED APPLICATIONS

This application claims the benefit of U.S. Provisional Patent Application No. 63/657,212, filed Jun. 7, 2024, the entire contents of which are incorporated by reference herein.

### TECHNICAL FIELD

Embodiments of the disclosure relate generally to memory sub-systems, and more specifically, relate to implementing host-side operations associated with tagged capacity in a memory device.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 is a block diagram of an example system for implementing host-side operations associated with tagged capacity in a compute express link (CXL) memory device in accordance with some embodiments of the present disclosure.

FIG. 3A illustrates an example tag mapping data structure and an example host mapping data structure that can be used to implement the aggregation operations associated with tagged capacity in a compute express link (CXL) memory device in accordance with some embodiments of the present disclosure.

FIG. 3B illustrates an example tag mapping data structure and an example host mapping data structure that can be used to implement the copy on write (COW) operations associated with tagged capacity in a compute express link (CXL) memory device in accordance with some embodiments of the present disclosure.

FIGS. 4A and 4B are flow diagrams of example methods for using aggregation operations associated with tagged capacity in a compute express link (CXL) memory device in accordance with some embodiments of the present disclosure.

FIG. 5 is a flow diagram of an example method for using copy on write (COW) operations associated with tagged capacity in a compute express link (CXL) memory device in accordance with some embodiments of the present disclosure.

FIG. 6 is a block diagram of an example computer system in which embodiments of the present disclosure may operate.

### DETAILED DESCRIPTION

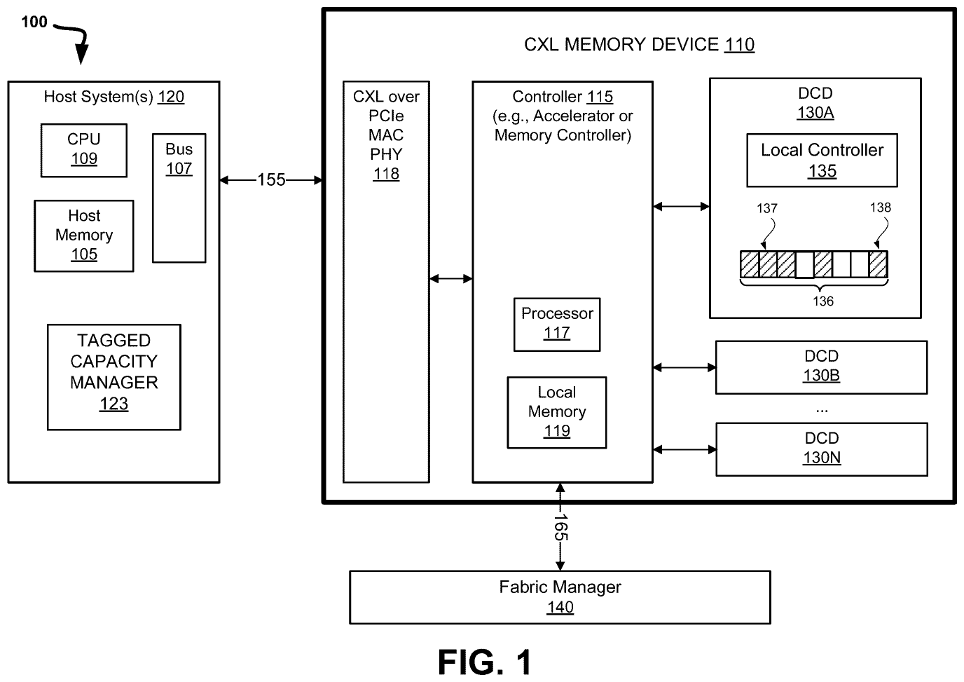

Aspects of the present disclosure are directed to implementing host-side operations associated with tagged capacity in a compute express link (CXL) memory device. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A compute express link (CXL) system is an optionally cache-coherent interconnect for processors, memory expansion, and accelerators. A C×L system maintains memory coherency between the CPU memory space and memory on attached devices, which allows resource sharing for higher performance, reduced software stack complexity, and lower overall system cost. Generally, CXL is an interface standard that can support a number of protocols that can run on top of PCIe, including a CXL.io protocol, a CXL.mem protocol and a CXL.cache protocol. The CXL.io protocol is a PCIe-like protocol that can be viewed as an “enhanced” PCIe protocol capable of carving out managed memory. CXL.io can be used for initialization, link-up, device discovery and enumeration, register access, and can provide an interface for I/O devices. The CXL.mem protocol can enable host access to the memory of an attached device using memory semantics (e.g., load and store commands). This approach can support both volatile and persistent memory architectures. The CXL.cache protocol can define host-device interactions to enable efficient caching of host memory with low latency using a request and response approach. Traffic (e.g., NVMe traffic) can run through the CXL.io protocol, and the CXL.mem and CXL.cache protocols can share a common link layer and transaction layer. Accordingly, the CXL protocols can be multiplexed and transported via a PCIe physical layer.

A memory device that supports CXL protocols and can be attached to a host via CXL is referred to as a CXL memory device, which can provide additional bandwidth and capacity to host processors. The CXL memory device is independent of the host memory. In some implementations, the CXL memory device may partition resources into multiple logical devices, and each logical device can be visible as a memory device. In some implementations, the CXL memory device may support multiple host systems. A fabric manager is an entity separate from the host system or the logical device that controls aspects related to binding and management of shared ports and devices, and the fabric manager may configure resource allocation for multiple host systems across the logical devices. Dynamic capacity (DC) is a feature of a CXL memory device that allows exposed memory capacity to be allocated and freed dynamically without the need for resetting the CXL memory device. Although the CXL memory device is used here as an illustrative example for implementing the dynamic capacity, the dynamic capacity feature can be applied to other memory devices.

Specifically, a dynamic capacity device (DCD) is a memory device, such as a CXL memory device, that implements dynamic capacity (DC). The device physical address (DPA) range of a DCD can be subdivided into several regions (e.g., 1 to 8 regions) and each of these regions may be further subdivided into a set of blocks. The fabric manager can allocate one or more blocks to a host system and associate the block(s) with a tag by assigning the tag to the block(s), where the block(s) collectively can be referred to as a taggable DC unit before being assigned to a tag, and referred to as a tagged capacity unit after being assigned to a tag. The taggable DC unit may represent a management unit that is taggable in various capacities, and can be dynamically allocated to various host systems. Each tag is globally unique, and thus the tags collectively can form an aggregate tag space in the memory device, such as the CXL memory device, and each tag in the aggregate tag space is uniquely identifiable. Each tag can be associated with one or more host systems and may be mapped to one or more DPA ranges (e.g., a set of one or more contiguous physical address ranges or physical address extent-lists (i.e., non-contiguous address ranges) that identify respective locations storing the data on the DCDs). Each tag may be shareable or not.

Specifically, the fabric manager controls the allocation of these taggable DC units to one or more host systems (or a group of host systems) and utilizes events to signal the host systems when changes to the allocation of these taggable DC units occurs. The fabric manager also assigns a tag to the allocated taggable DC units by associating, in a tag mapping data structure, the tag with the taggable DC units represented by one or more physical addresses (e.g., one or more DPA ranges). The memory device maps the DPA ranges to the taggable DC units. The tag can thus be referred to as representing the tagged capacity units. The host system can map these DPA ranges to corresponding host physical address (HPA) ranges within the host address space available to the host system. In some implementations, the memory device may communicate the state of these tagged capacity units through an extent list that describes the starting DPA and length of all blocks the host system can access, where the extent list is managed by the memory device. The host system may use a set of commands for querying and configuring the tagged capacity units. The set of commands may include a command requesting allocation of new tagged capacity units (e.g., Initiate Dynamic Capacity Add command), a command requesting release of the tagged capacity units (e.g., Initiate Dynamic Capacity Release command), and getting information of the tagged capacity units. The capacity of the sharable tagged capacity units associated with a tag and allocated to a host system is immutable such that no additional capacity can be added the tag, nor can capacity be deleted from the tag. Furthermore, although the content stored in the tagged capacity units can be modified, the mapping between the tag and the tagged capacity units allocated to the host system cannot be modified through the life of the sharable tag. If the capacity associated with a tag needs to be changed or a tag needs to be changed, a host system can, however, have to request re-allocation for new capacity of tagged capacity units or for new tags being associated with the taggable DC units. In one example, the capacity of the tagged capacity units associated with a tag and allocated to a host system may be too large or too small for the usage scenario of the host system, which would either waste system or memory resources or require another allocation operation. In another example, when the tagged capacity units associated with a tag are shared by multiple host systems, the host systems may not modify the content in the shared tagged capacity units.

Aspects of the present disclosure address the above and other deficiencies by implementing a host-side aggregation operation associated with tagged capacity and a copy-on-write (COW) operation associated with tagged capacity.

The aggregation operation associated with tagged capacity enables a process of a host system to aggregate multiple tags in a defined order such that the host system can access the data stored in the tagged capacity units associated with these tags. As described above, the fabric manager controls the allocation of these taggable DC units to a host system (or a group of host systems) and assigns these tags to allocated taggable DC units, and a controller of the DCD may store data to these tagged capacity units. The host system may receive tag information from the controller of the CXL memory device, where the tag information includes a list of these tags associated with the stored data, where these tags are listed in an order. The host system may map the logical address(es) of the data to these tags, for example, in a host mapping data structure. The host system may access the data by aggregating multiple DPA ranges, wherein each DPA range is associated with a respective tag of the tags.

In an illustrative example, a host system may generate or receive data to be stored in the tagged capacity of a DCD. The host system may send the data in an incremental manner. For example, the process of the host system (“host process”) may generate or receive data to be stored in the DCDs of the CXL memory device. Instead of sending the data in the full size, a tagged capacity manager running at the host side may send a portion of the data (referred to as a first portion of the data), for example, the portion is in a predefined size (referred to as the first predefined size). In response, the fabric manager or a controller of the memory device may allocate memory by determining a tagged capacity unit associated with a tag (referred to as the first tag) and allocating this tagged capacity unit to the host process, and store the first portion of the data in the tagged capacity unit associated with the first tag, and to this point, the tagged capacity manager may determine that only partial data, not the whole data, has been written to the memory device, and the tagged capacity manager may continue sending another portion of the data (referred to as a second portion of the data), for example, the portion is in a predefined size (referred to as the second predefined size). In response, the fabric manager or a controller of the memory device may allocate memory by determining another tagged capacity unit associated with another tag (referred to as the second tag) and allocating this tagged capacity unit to the host process, and store the second portion of the data in the tagged capacity unit associated with the second tag, and to this point, the tagged capacity manager may determine whether the whole data has been written to the memory device. If the tagged capacity manager determines that the whole data has been written to the memory device, the tagged capacity manager can map, to the logical address(es) of the data, the tags of the tagged capacity units that have been allocated to store the data. There tags can be mapped in an order such that when these tags are concatenated in the order, the host virtual address ranges corresponding to the tags are aggregated in the order to refer to an aggregated virtual address range of the relevant host processes. If the tagged capacity manager determines that not the whole of the data has been written to the memory device, the tagged capacity manager can continue sending the remaining portion of the data until the whole data has been written to the memory device. In all of these situations, the tagged capacity manager may maintain a host mapping data structure that records the mapping of all tags associated with the allocated memory for storing the data to the logical address(es) of the data.

As such, the memory of the tagged capacity can be allocated to the host process in an incremental manner such that there is no significant waste of the memory. The predefined size of each portion of the data may vary. In one example, the predefined size is the same for each portion of the data. In another example, the predefined size gets smaller after each portion is stored. The predefined size is customizable according to the need of the host process.

The copy on write (COW) operation associated with tagged capacity enables a process of a host system (e.g., a first process of a first host system) to access data stored in a tagged capacity unit associated with a tag (“original data of the tag”), where the tag is shared by multiple processes of same or different host systems (e.g., the first process of the first host system and the second process of the second host system) such that each process can perform operations on the data using the respective version. Specifically, the tagged capacity manager may maintain a mapping that maps each process to the tag such that each process can read the original data of the tag by referencing the same physical locations mapped to the tag without the need of a duplicate of the original data. When one process (e.g., the first process) attempts to write data to the tagged capacity unit associated with the tag, the tagged capacity manager can copy the original data of the tag to a local host memory and write data (e.g., modify the original data) to the local host memory. The tagged capacity manager may update the mapping by adding a mapping between the process and the physical address(es) of the local host memory that stores the modified data. In some implementations, the process may request to store the modified data in the local host memory (e.g., serving as cache) to another tagged capacity unit associated with a new tag.

As such, by using the copy on write (COW) operation associated with tagged capacity, the tagged capacity manager manages storage devices to efficiently implement a duplicate or copy operation on modifiable resources in a local host memory. The original data of the tag is kept as it is, preventing the confusion caused by multiple processes modifying the original data, and a host process can access (e.g., by referencing the local host memory or the new tag) the modified data. If data associated with a tag is shared but not modified, it is not necessary to create new data as the duplicate, and the original data can be read referencing the same physical location.

Advantages of the present disclosure include efficient modification of tagged capacity units allocated to a host system by using host-side operations associated with tagged capacity. Specifically, the system significantly improves flexibility in using the tagged memory capacity.

FIG. 1 illustrates an example computing system 100 that includes a compute express link (CXL) memory device 110 in accordance with some embodiments of the present disclosure. The CXL memory device 110 can include media, such as one or more volatile memory devices, one or more non-volatile memory devices, or a combination of such.

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include one or more host system(s) 120 that are coupled to the CXL memory device 110. In some embodiments, the host system 120 is coupled to multiple CXL memory devices 110 of different types. FIG. 1 illustrates one example of a host system 120 coupled to one CXL memory device 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the CXL memory device 110, for example, to write data to the CXL memory device 110 and read data from the CXL memory device 110.

The host system 120 can be coupled to the CXL memory device 110 via a peripheral component interconnect express (PCIe) interface. The PCIe interface is a physical host interface used to transmit data between the host system 120 and the CXL memory device 110 for passing control, address, data, and other signals between the CXL memory device 110 and the host system 120. The host system 120 can further utilize a CXL interface to access components of the CXL memory device 110 when the CXL memory device 110 is coupled with the host system 120 by the physical host interface (e.g., PCIe bus). FIG. 1 illustrates a CXL memory device 110 as an example. In general, the host system 120 can access multiple CXL memory devices 110 via a same communication connection, multiple separate communication connections, and/or a combination of communication connections.

In some embodiments, the host system 120 includes a central processing unit (CPU) 109 connected to a host memory 105, such as DRAM or other main memories. The host system 120 includes a bus 107, such as a memory device interface, which interacts with a host interface 118, via a CXL connection 155.

The CXL connection 155 can include a set of data-transmission lanes (“lanes”) for implementing CXL protocols, including CXL.io protocol, CXL.mem protocol, and CXL.cache protocol. The CXL connection 155 can include any suitable number of lanes in accordance with the embodiments described herein. For example, the CXL connection 155 can include 16 lanes (i.e., CXL x16).

The host interface 118 may include media access control (MAC) and physical layer (PHY) components, of CXL memory device 110 for ingress of communications from host system 120 to CXL memory device 110 and egress of communications from CXL memory device 110 to host system 120. Bus 107 and host interface 118 operate under a communication protocol, such as a CXL over PCIe serial communication protocol or other suitable communication protocols. Other suitable communication protocols include Ethernet, serial attached SCSI (SAS), serial AT attachment (SATA), any protocol related to remote direct memory access (RDMA) such as Infiniband, iWARP, or RDMA over Converged Ethernet (RoCE), and other suitable serial communication protocols.

The computing system 100 may be a cache-coherent interconnect for processors, memory expansion, and accelerators. The computing system 100 maintains memory coherency between the CPU memory space and memory on attached devices, which allows resource sharing for higher performance, reduced software stack complexity, and lower overall system cost. Generally, CXL is an interface standard that can support a number of protocols that can run on top of PCIe, including a CXL.io protocol, a CXL.mem protocol and a CXL.cache protocol. The CXL.io protocol is a PCIe-like protocol that can viewed as an “enhanced” PCIe protocol capable of carving out managed memory. CXL.io can be used for initialization, link-up, device discovery and enumeration, register access, and can provide an interface for I/O devices. The CXL.mem protocol can enable host access to the memory of an attached device using memory semantics (e.g., load and store commands). This approach can support both volatile and persistent memory architectures. The CXL.cache protocol can define host-device interactions to enable efficient caching of host memory with low latency using a request and response approach. Traffic (e.g., NVMe traffic) can run through the CXL.io protocol, and the CXL.mem and CXL.cache protocols can share a common link layer and transaction layer. Accordingly, the CXL protocols can be multiplexed and transported via a PCIe physical layer.

The CXL memory device 110 is a memory device that allows the host system 120 to use it for memory bandwidth expansion, memory capacity expansion, and potentially persistent memory applications, and as small-scale resource pooling, and large-scale resource pooling and sharing.

In some implementations, the CXL memory device may be a multiple logical device (MLD), which may partition resources into multiple logical devices, and each logical device can be visible as a memory device. One of multiple logical devices can be reserved for a fabric manager to configure resource allocation across the logical devices, while the other logical devices can be available for assigning to the host. In some implementations, the CXL memory device may be a device that supports multiple host systems and may be referred to as fabric-attached memory (FAM). In the context of these computing environments, the term “fabric” can refer to interconnected communication paths that route signals on major components of a chip or between chips of a computing system. This “fabric” can form the architecture of interconnections between processing or compute nodes within a computing device or between multiple computing devices. In this context, processing nodes and compute nodes refer to processing devices operating as nodes on an interconnected network. Fabric-attached memory can refer to a memory architecture in which the memory is connected to the CPU through a fabric interconnect, rather than being directly connected to the CPU. This allows for the memory to be located at a distance from the CPU and can provide benefits such as improved scalability and fault tolerance. For example, in some systems, the fabric includes a bus or a set of connections that connect the processing device of the system to peripheral devices and other processing devices. In other systems, the fabric can also include a set of network connections between combinations of respective compute nodes and memory nodes. In various systems, the fabric acts as an interconnect to create a network of interconnected devices that work together as a single entity. This unified framework incorporates many interconnected devices via the fabric (i.e., like many threads woven together to create a cohesive whole) to provide fast and reliable communication between the devices. In this context, an “interconnect” can refer to a device or system that connects multiple devices or subsystems together to allow them to communicate and exchange data.

The CXL memory device 110 can include a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The CXL memory device 110 can include any combination of the different types of non-volatile memory devices and/or volatile memory devices. The volatile memory devices can be, but are not limited to, random access memory (RAM), such as dynamic random access memory (DRAM) and synchronous dynamic random access memory (SDRAM). Some examples of non-volatile memory devices include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

The DCD 130A-130N can include volatile memory devices including, random access memory (RAM), such as dynamic random access memory (DRAM) and synchronous dynamic random access memory (SDRAM), and non-volatile memory devices including a not-and (NAND) type flash memory and write-in-place memory, such as a 3D cross-point memory device, which is a cross-point array of non-volatile memory cells, read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A CXL memory device controller 115 can communicate with the DCD 130A-130N to perform operations such as reading data, writing data, or erasing data at the DCD 130A-130N and other such operations. The CXL memory device controller 115 can include hardware such as one or more integrated circuits and/or discrete components, a buffer memory, or a combination thereof. The hardware can include a digital circuitry with dedicated (i.e., hard-coded) logic to perform the operations described herein. The CXL memory device controller 115 can be a microcontroller, special purpose logic circuitry (e.g., a field programmable gate array (FPGA), an application specific integrated circuit (ASIC), etc.), or other suitable processors.

The CXL memory device controller 115 can include a processing device, which includes one or more processors (e.g., processor 117), configured to execute instructions stored in a local memory 119. In the illustrated example, the local memory 119 of the CXL memory device controller 115 includes an embedded memory configured to store instructions for performing various processes, operations, logic flows, and routines that control operation of the CXL memory device 110, including handling communications between the CXL memory device 110 and the host system 120. The CXL memory device controller 115 may manage operations of CXL memory device 110, such as writes to and reads from DCD 130A-130N. The CXL memory device controller 115 may include one or more processors 117, which may be multi-core processors. Processors 117 can handle or interact with the components of DCD 130A-130N, generally through firmware code. The CXL memory device controller 115 may operate under CXL protocol, but other protocols are applicable.

The CXL memory device controller 115 executes computer-readable program code (e.g., software or firmware) executable instructions (herein referred to as “instructions”). The instructions may be executed by various components of CXL memory device controller 115, such as processor 117, logic gates, switches, application specific integrated circuits (ASICs), programmable logic controllers, embedded microcontrollers, and other components of CXL memory device controller 115. The instructions executable by the CXL memory device controller 115 for carrying out the embodiments described herein are stored in a non-transitory computer-readable storage medium. In certain embodiments, the instructions are stored in a non-transitory computer readable storage medium of CXL memory device 110, such as DCD 130A-130N. Instructions stored in the CXL memory device 110 may be executed without added input or directions from the host system 120. In other embodiments, the instructions are transmitted from the host system 120. The CXL memory device controller 115 is configured with hardware and instructions to perform the various functions described herein and shown in the figures.

The CXL memory device controller 115 may interact with DCD 130A-130N for read and write operations. The CXL memory device controller 115 may execute the direct memory access (DMA) for data transfers between host system 120 and DCD 130A-130N without involvement from CPU 109. The CXL memory device controller 115 may control the data transfer while activating the control path for fetching commands, posting completion and interrupts, and activating the DMA for the actual data transfer between host system 120 and DCD 130A-130N. The CXL memory device controller 115 can have an error correction module to correct the data fetched from the memory arrays in the DCD 130A-130N.

In some embodiments, the local memory 119 can include memory registers storing memory pointers, fetched data, etc. The local memory 119 can also include read-only memory (ROM) for storing micro-code. While the example CXL memory device 110 in FIG. 1 has been illustrated as including the CXL memory device controller 115, in another embodiment of the present disclosure, a CXL memory device 110 does not include a CXL memory device controller 115, and can instead rely upon external control (e.g., provided by an external host, or by a processor or controller separate from the memory sub-system).

In general, the CXL memory device controller 115 can receive commands or operations from the host system 120 or the fabric manager 140 and can convert the commands or operations into instructions or appropriate commands to achieve the desired access to the DCD 130A-130N. The CXL memory device controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical MU address, physical block address) that are associated with the DCD 130A-130N. The CXL memory device controller 115 can further include host interface circuitry to communicate with the host system 120 via the physical host interface. The host interface circuitry can convert the commands received from the host system into command instructions to access the DCD 130A-130N as well as convert responses associated with the DCD 130A-130N into information for the host system 120.

The CXL memory device 110 can also include additional circuitry or components that are not illustrated. In some embodiments, the CXL memory device 110 can include a cache or buffer (e.g., DRAM) and address circuitry (e.g., a row decoder and a column decoder) that can receive an address from the CXL memory device controller 115 and decode the address to access the DCD 130A-130N.

In some embodiments, each or some of DCDs 130A-130N include local media controllers 135 that operate in conjunction with CXL memory device controller 115 to execute operations on one or more memory cells of the DCDs 130A-130N. An external controller (e.g., CXL memory device controller 115) can externally manage the DCDs 130A-130N (e.g., perform media management operations on the memory device 130). In some embodiments, CXL memory device 110 is a managed memory device, which is a raw DCDs 130A-130N having control logic (e.g., local media controller 135) on the die and a controller (e.g., CXL memory device controller 115) for media management within the same memory device package. An example of a managed memory device is a managed NAND (MNAND) device.

In some embodiments, the computing system 100 can include a fabric manager 140. The fabric manager 140 is an entity external to the host system 120 and the CXL memory device 1120 and that queries and configures the operational state of the computing system 100, and may include application logic and policy that makes the assignments of DCDs 130A-130N to the host system 120 at run time. In some embodiments, the fabric manager 140 may be software running on the host system 120, firmware embedded within a specialized processor used for remote monitoring and management of the host system 120 (e.g., a Baseboard Management Controller (BMC)) on another CXL device or a CXL switch, or a dedicated device running in the CXL device. The fabric manager 140 may assign a device (e.g., DCDs 130A-130N) to the host system 120 by using command sets through the interface 165 (e.g., Component Command Interface (CCI)). CCI may be exposed through mailbox registers, which provide the ability to issue a command (“mailbox command”) to the device (e.g., DCDs 130A-130N). In some implementations, each of the DCD 130A-130N can include one or more taggable DC units 136. In the example of FIG. 1, the fabric manager 140 may assign a taggable DC units to the host system 120 and create a globally unique tag attached to the taggable DC unit (as a tagged capacity unit) 137; the fabric manager 140 may assign another taggable DC unit to the host system 120 and create a globally unique tag attached to the taggable DC unit (as a tagged capacity unit) 138. Although specific number of taggable dynamic capacity units is shown in FIG. 1 and taggable dynamic capacity units shown in FIG. 1 have the same size of capacity, various sizes of capacities can be allocated to the taggable dynamic capacity units according to the request of the host systems, and the number of taggable dynamic capacity units included in a DCD can vary. In some implementations, the capacity size of a taggable dynamic capacity unit may be a multiple of a minimum capacity size, and the minimum capacity size may be 2 MB, 0.5 GB, 1 GB, etc. In some implementations, some or all of the functionality of the fabric manager 140 may be performed by the controller 115.

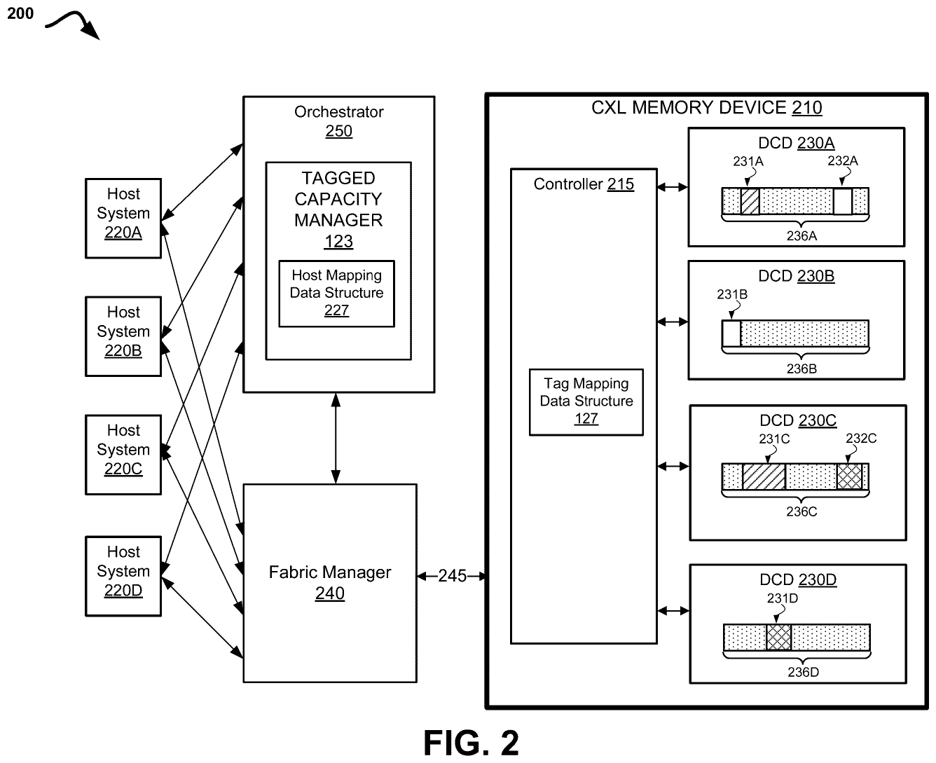

In some embodiments, the host system 120 includes a tagged capacity manager 123 that enables the host system 120 to perform the host-side operations associated with tagged capacity. In some embodiments, the CXL memory device controller 115 performs at least some functions of the tagged capacity manager 123. In some embodiments, the tagged capacity manager 123 is part of the CXL memory device 110, an application, or an operating system. Further details regarding the operations of the tagged capacity manager 123 are described below with reference to FIGS. 2-6. In some implementations, the tagged capacity manager 123 may be included in orchestrator 250 as shown in FIG. 2. In some implementations, some or all of the functionalities of the tagged capacity manager 123 may be performed by the fabric manager 240, the controller 215, and/or the combination thereof, as shown in FIG. 2.

In some implementations, additional circuitry and signals can be provided, and that the components of FIG. 1 have been simplified. It should be recognized that the functionality of the various block components described with reference to FIG. 1 may not necessarily be segregated to distinct components or component portions of an integrated circuit device. For example, a single component or component portion of an integrated circuit device could be adapted to perform the functionality of more than one block component of FIG. 1. Alternatively, one or more components or component portions of an integrated circuit device could be combined to perform the functionality of a single block component of FIG. 1.

FIG. 2 is a schematic block diagram of a system 200 implementing taggable dynamic capacity units in a compute express link (CXL) memory device. In various embodiments, the system 200 includes one or more host systems 220A-D (such as the host system 120), a CXL memory device 210 (such as the CXL memory device 110) that includes a controller 215 (such as controller 115), a CXL fabric interconnect 245, a fabric manager 240 that can perform operations managing the CXL fabric interconnect 245, and an orchestrator 250. In some embodiments, aspects of the controller 215 are included in the processing logic of DCDs 230A-230D. The CXL memory device 210 can be connected to the host systems 220A-D via a network connection interface utilizing the high-speed bus (e.g., a Peripheral Component Interconnect Express (PCIe) bus), such as a compute express link (CXL) fabric interconnect 245. The compute express link (CXL) fabric interconnect 245 may provide an interface that can support several protocols that can run on top of PCIe, including a CXL.io protocol, a CXL.mem protocol, and a CXL.cache protocol. The CXL fabric interconnect 245 may be a collection of one or more switches, and each switch is port based routing (PBR) capable and interconnected with PBR links. The CXL fabric interconnect 245 can connect one or more host ports to the devices within a single coherent host physical address (HPA) space.

In the example of FIG. 2, the DCD 230A may include a first region 236A, the DCD 230B may include a second region 236B, the DCD 230C may include a third region 236C, and the DCD 230D may include a fourth region 236D. As shown in FIG. 2, each region of the first region 236A, second region 236B, third region 236C, and fourth region 236D may include one or more taggable dynamic capacity units. Although the regions are illustrated in FIG. 2 as in the uniform size of capacity, the regions can have various capacity sizes.

In some implementations, the orchestrator 250 may control the accessibility to each tag by the host systems 220A-D. The orchestrator 250 may make global control and management decisions about a cluster of the host systems 220A-D. The orchestrator 250 may be responsible for maintaining the desired state (i.e., a state desired by a client when running the cluster) of the host systems 220A-D, such as which applications are running and which container images they use, which resources should be made available for them, and other configuration details. In some implementations, the orchestrator 250 may be a container orchestration system, such as Kubernetes. In some implementations, the orchestrator 250 may be used to provide a containerized computing services platform, such as a Platform-as-a-Service (PaaS) system. The PaaS system provides resources and services (e.g., micro-services) for the development and execution of applications owned or managed by multiple users. A PaaS system provides a platform and environment that allow users to build applications and services in a clustered compute environment (the “cloud”). The orchestrator 250 may include nodes to execute applications and/or processes associated with the applications. A “node” providing computing functionality may provide the execution environment for an application. In some implementations, the “node” may include a virtual machine that is hosted on a physical machine, such as the host system 220A-220D implemented as part of the clouds. In some implementations, nodes may additionally or alternatively include a group of virtual machines, a container, or a group of containers to execute functionality of the PaaS applications. When nodes are implemented as virtual machines, they may be executed by operating systems (OSs) on each host system 220A-220D. Although implementations of the disclosure are described in accordance with a certain type of system, this should not be considered as limiting the scope or usefulness of the features of the disclosure. For example, the features and techniques described herein can be used with other types of multi-tenant systems and/or containerized computing services platforms.

The orchestrator 250 may include a tagged capacity manager 123. The tagged capacity manager 123 may perform the host-side operations associated with tagged capacity. The tagged capacity manager 123 may maintain a host mapping data structure 227 to be used in the host-side operations. The details of the tagged capacity manager 123 and the host mapping data structure 227 are described below with respect to FIG. 2. The implementation of the aggregation operation is illustrated as an example using the host system 220A, and the DCDs 230A and 230B, while the implementation of the COW operation is illustrated as an example using the host system 220C and 220D, and the DCDs 230C. It is noted that each of the aggregation operation and the COW operation can be implemented by one or more host systems, one or more nodes, and/or one or more DCDs.

In some implementations of the aggregation operation, the host systems 220A-D (e.g., through a node running on the host systems 220A-D) may request allocation of tagged capacity in DCDs 230A-230D. Using the host system 220A, and the DCDs 230A, 230B as an example, the host system 220A, through the node (e.g., an application, a virtual machine) running on the host systems 220A-D, may generate or receive data to be stored in DCDs 230A-230D. The data may be created or received by an application running on a node. The data can include content that is reflective of a state of the application (e.g., the data can include information that represents the values of the variables, the memory layout, the position of the instruction pointer, and other details about the state of the application).

While the detailed steps are described below, to summarize, the tagged capacity manager 123 may send a portion of the data to the DCDs 230A-230D, where the portion of the data is in a predefined size. The tagged capacity manager 123 may receive tag information from the DCDs 230A-230D, where the portion of the data is stored in a tagged capacity unit associated with a tag. The tagged capacity manager 123 may determine whether there is remaining data after the portion of the data has been stored. The tagged capacity manager 123 may continue sending the remaining data in a predefined size until the whole data has been stored. The tagged capacity manager 123 may map these tags to a logical address of the data such that these tags can be concatenated to access the data.

In various implementations, each time the tagged capacity is allocated, a globally unique tag is created by the fabric manager 240 and is associated with the allocated portions of the DCDs 230A-230D. The controller 215 may receive the host identifier (or a host group identifier) along with the data to be stored in the tag from the host system. The controller 215 may store, in the tag mapping data structure 127, the tag, the DPA ranges of the allocated portions, of the DCDs 230A-230D, associated with the tag, and the host identifier (or a host group identifier) that defines the host system(s) that can access the tag. The tag mapping data structure 127 may be used to map the one or more DPA ranges identifying respective locations containing the data on the CXL memory device 210 with corresponding virtual address ranges in the virtual address space available to the host system (i.e., the virtual/logical address space allocated by a host system to the host application that created the data). As such, the data associated with the tag can be accessed at respective locations identified by a set of corresponding address ranges (e.g., contiguous physical address range or extent list of non-contiguous physical address ranges indicating the locations on the CXL memory device 210 of the data). The data associated with the tag can include content that is reflective of a state of the application (e.g., the data can include information that represents the values of the variables, the memory layout, the position of the instruction pointer, and other details about the state of the application).

The tagged capacity manager 123 may generate an aggregation identifier, for each host request, to identify all tags associated with the allocated memory for the host request. In some implementations, the tagged capacity manager 123 may generate an aggregation identifier responsive to receiving the host request to store the data, or responsive to completing the storage of the data. That is, all tags that are assigned to the same aggregation identifier are to be concatenated to access the data that has been stored in the DCDs 230A-230D. The tagged capacity manager 123 can thus associate each tag assigned for the host request with the aggregation identifier. The tagged capacity manager 123 may store, in the host mapping data structure 227, the tag, the logical address of the data, and the aggregation identifier associated with the tag.

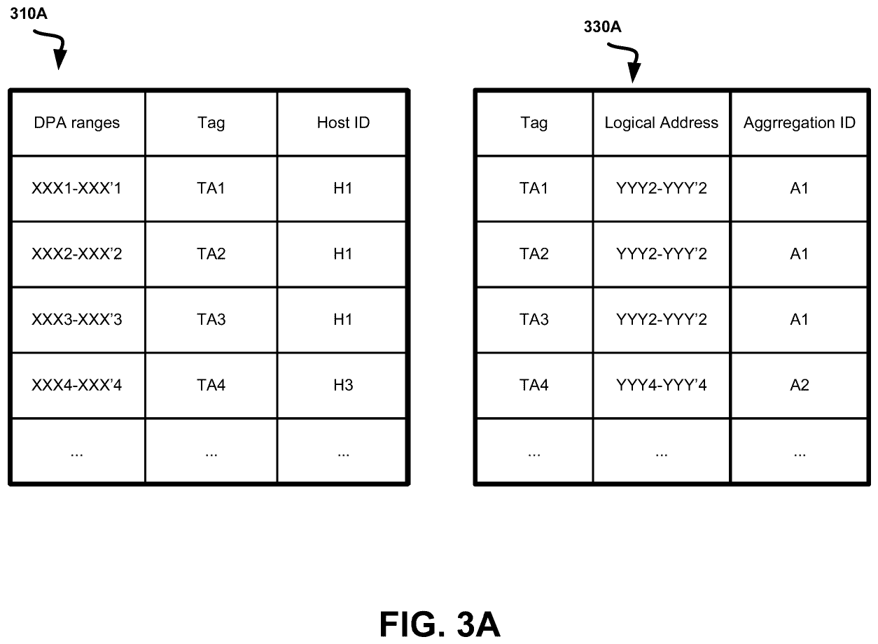

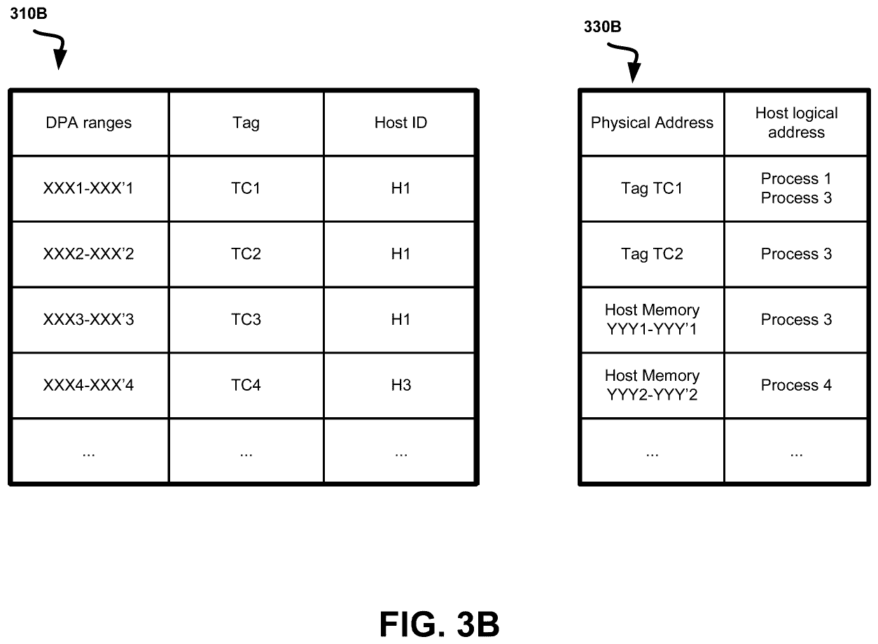

FIG. 3A illustrates an example tag mapping data structure 310A (such as the tag mapping data structure 127) and an example host mapping data structure 330A (such as the host mapping data structure 227) that can be used to implement the aggregation operations associated with tagged capacity. The tag mapping data structure 310A may include an item “DPA ranges,” an item “tag,” and an item “host ID.” The item “DPA ranges” indicates the locations (i.e., one or more physical address ranges of the tagged capacity unit) storing the respective data on the CXL memory device. The physical address ranges identifying respective locations on the CXL memory device storing the data can be referred to as “the physical address ranges of the tagged capacity unit” containing data. The item “tag” indicates the tag associated with the tagged capacity unit. The item “host ID” indicates the host system from which the tagged capacity unit associated with the tag can be accessed. The mapping data structure 310A may include multiple records, and each record may correspond to a tag, and each record include multiple items as described above.

Using the item “DPA ranges,” an item “tag,” an item “host ID,” the tag mapping data structure 310A can be used to map the DPA ranges to the host system by mapping the physical address ranges of the tag to corresponding virtual address ranges in a virtual address space of the host system (i.e., the virtual/logical address space allocated by a host system to a host application that is permitted to access the data).

As shown in FIG. 3A, the host mapping data structures 330A may include an item “tag” and an item “logical address.” The item “logical address” indicates the address or address ranges of the virtual/logical address space allocated by a host system to the host application that created or relayed the data and can be mapped by the host system to the tag. The host mapping data structures 330A may further include an item “aggregation ID.” The item “aggregation ID” indicates the tag associated with it can be aggregated to the tag(s) associated with the same aggregation ID. As such, by using the item “aggregation ID,” the tag mapping data structure 300A can be used to concatenate, in a defined order, the tag(s) associated with the same aggregation ID. In some implementations, the defined order is determined according to the time in which the tags have been assigned, for example, the earlier assigned tag is concatenated before the later assigned tag in the time order. In some implementations, the defined order is determined according to the value that has been used as tag, for example, the smaller value of the tag is concatenated before the larger value of the tag in the value order.

Now referring back to FIG. 2, the host system 220A may send a request to store the data in the CXL memory device 210, where the request may include the data and the logical address of the data. While the host system 220A keeps sending the data, the tagged capacity manager 123 may start the operations described below without waiting for the completion of sending the data by the host system 220A. For example, upon receiving a portion of the data in a specified (e.g., arbitrary or predefined) size, the tagged capacity manager 123 may send, to the controller 215 and/or the fabric manager 240, a first portion of the data in a first predefined size. The tagged capacity manager 123 may send the first portion of the data with a host identifier. The controller 215 and/or the fabric manager 240 may determine the portions of the DCDs 230A-230D for the initial allocation. In some implementations, the controller 215 may determine an available portion, of a size same as the first predefined size, of the DCDs 230A-230D to be allocated to the host system 220A and request the fabric manager 240 to provide a tag. The controller 215 may receive the tag from the fabric manager 240 and assign the tag (e.g., TA1 in FIG. 3A) to the allocated portion referred to as the tagged capacity unit, for example, the tagged capacity unit 231A. In some implementations, the fabric manager 240 may identify an available portion, in a size same as the first predefined size, of the DCDs 230A-230D to be allocated to the host system 220A and assign a tag (e.g., TA1 in FIG. 3A) to the allocated portion referred to as the tagged capacity unit, for example, the tagged capacity unit 231A. The controller 215 may store, in the tag mapping data structure 127, the tag (e.g., TA1 in FIG. 3A), the DPA ranges of the tagged capacity unit 231A, and the host identifier (or a host group identifier) that defines the host system(s) 220A that can access the tag.

Upon the allocation of the tagged capacity unit 231A, the controller 215 may store the first portion of the data in the tagged capacity unit 231A. The controller 215 can map the one or more DPA ranges identifying respective locations containing the first portion of the data on the CXL memory device 210 with corresponding virtual address ranges in the virtual address space available to the host system 220A (i.e., the virtual/logical address space allocated by a host system to the host application that created the data). As such, the controller 215 can access the first portion of the data at respective locations identified by a set of corresponding addresses (e.g., contiguous physical address range(s) or extent list of non-contiguous physical address range(s) indicating the locations on the CXL memory device 210 of the data). The controller 215 may send tag information associated with the first portion of the data to the tagged capacity manager 123. The tagged capacity manager 123 may map the tag to the logical address of the data and store, in the host mapping data structure 227, the tag (e.g., TA1 in FIG. 3A), the logical address of the data (e.g., YYY2-YYY′2 in FIG. 3A), and the aggregation ID associated with the tag (e.g., A1 in FIG. 3A).

The tagged capacity manager 123 may determine whether the total stored size, now equaling the first predefined size, reaches or exceeds the whole size of the data. Upon determining that the total stored size reaches or exceeds the capacity size specified in the host request, the tagged capacity manager 123 may send, to the host system 220A, a notification indicating the completion of storing the data.

Upon determining that the total stored size has neither reach nor exceed the whole size of the data, the tagged capacity manager 123 may send, to the controller 215 and/or the fabric manager 240, a second portion of data in a second predefined size. The tagged capacity manager 123 may send the second portion of the data with a host identifier. The controller 215 and/or the fabric manager 240 may determine the portions of the DCDs 230A-230D for the additional allocation. In some implementations, the controller 215 may identify an available portion, in a size same as the second predefined size, of the DCDs 230A-230D to be allocated to the host system 220A and request the fabric manager 240 providing a tag. The controller 215 may receive the tag from the fabric manager 240 and assign the tag (e.g., TA2 in FIG. 3A) to the allocated portion referred to as the tagged capacity unit, for example, the tagged capacity unit 232A. In some implementations, the fabric manager 240 may determine an available portion, in a size same as the second predefined size, of the DCDs 230A-230D to be allocated to the tagged capacity unit 232A and assign a tag (e.g., TA2 in FIG. 3A) to the allocated portion referred to as the tagged capacity unit, for example, the tagged capacity unit 232A. The controller 215 may store, in the tag mapping data structure 127, the tag (e.g., TA2 in FIG. 3A), the DPA ranges of the tagged capacity unit 232A, the host identifier (or a host group identifier) that defines the host system(s) 220A that can access the tag.

Upon the allocation of the tagged capacity unit 232A, the controller 215 may store the second portion of the data in the tagged capacity unit 232A. The controller 215 can map the one or more DPA ranges identifying respective locations containing the second portion of the data on the CXL memory device 210 with corresponding virtual address ranges in the virtual address space available to the host system 220A (i.e., the virtual/logical address space allocated by a host system to the host application that created the data). As such, the controller 215 can access the second portion of the data at respective locations identified by a set of corresponding addresses (e.g., contiguous physical address range(s) or extent list of non-contiguous physical address range(s) indicating the locations on the CXL memory device 210 of the data). The controller 215 may send tag information associated with the second portion of the data to the tagged capacity manager 123. The tagged capacity manager 123 may map the tag to the logical address of the data and store, in the host mapping data structure 227, the tag (e.g., TA2 in FIG. 3A), the logical address of the data (e.g., YYY2-YYY′2 in FIG. 3A), and the aggregation ID associated with the tag (e.g., A1 in FIG. 3A).

The tagged capacity manager 123 may determine whether the total stored size, now equaling a sum of the first predefined size and the second predefined size, reaches or exceeds the whole size of the data. Upon determining that the total stored size reaches or exceeds the whole size of the data, the tagged capacity manager 123 may send, to the host system 220A, a notification indicating the completion of the host request.

Upon determining that the total stored size has neither reach nor exceed the whole size of the data, the tagged capacity manager 123 may continue sending the remaining data until that the total stored size reaches or exceeds the whole size of the data. For example, the tagged capacity manager 123 may send, to the controller 215 and/or the fabric manager 240, a third portion of data in a third predefined size. The tagged capacity manager 123 may send the third portion of the data with a host identifier. In response, the controller 215 and/or the fabric manager 240 may allocate the tagged capacity unit 231B associated with a tag (e.g., TA3 in FIG. 3) to the host system 220A, and the controller 215 may write the third portion of data to the tagged capacity unit 231B. The controller 215 may store, in the tag mapping data structure 127, the tag (e.g., TA3 in FIG. 3A), the DPA ranges of the tagged capacity unit 231B, and the host identifier (or a host group identifier) that defines the host system(s) 220A that can access the tag. The controller 215 may send tag information associated with the third portion of the data to the tagged capacity manager 123. The tagged capacity manager 123 may map the tag to the logical address of the data and store, in the host mapping data structure 227, the tag (e.g., TA3 in FIG. 3A), the logical address of the data (e.g., YYY2-YYY′2 in FIG. 3A), and the aggregation ID associated with the tag (e.g., A1 in FIG. 3A).

Assuming that after the allocations of the tagged capacity units 231A, 232A, and 231B, the total stored size has reached or exceeded the whole size of the data, the tagged capacity manager 123 may send, to the host system 220A, a notification indicating the completion of the host request. The tagged capacity manager 123 may map the tags to virtual/logical address ranges in the virtual/logical address space available to the host system 220A (i.e., the virtual/logical address space allocated by a host system to the host application that created the data) such that the host system 220A can identify the physical locations storing the data by using the aggregation identifier in the host mapping data structure 127. Using an example illustrated in FIG. 3A, when the host system 220A generates a request to read data associated with the virtual/logical address (or the aggregation identifier A1), the tagged capacity manager 123 may find in the host mapping data structure 330A, the tags that have been mapped to the logical address of the data (e.g., YYY2-YYY′2) (or e.g., the aggregation identifier A1, i.e., tag TA1, tag TA2, tag TA3). The tagged capacity manager 123 may find, in the tag mapping data structure 310A, the DPA ranges mapped to tag TA1, tag TA2, tag TA3, and aggregate the DPA ranges XXX1-XXX′1, XXX2-XXX′2, XXX3-XXX′3 in the order of tag TA1, tag TA2, tag TA3. The aggregated DPA ranges is the physical addresses in which the data can be accessed by the host system 220A by using the logical address of the data.

In some implementations of the COW operations, a process of the host systems 220A-D (e.g., through a node running on the host systems 220A-D) may request to access data associated with a tag, where the tag is shared by multiple processes of the host systems 220A-D. Using the host systems 220C, 220D, and the DCD 230C as an example, a process of the host system 220C, through the node (e.g., an application, a virtual machine) running on the host systems 220A-D, may request to access data stored in the tagged capacity unit 231C, where the tagged capacity unit 231C is associated with a tag, and the tag is shared by the process of the host system 220C and a process of the host system 220D. The data stored in the tagged capacity unit 231C associated with a tag can be referred to as original data of the tag. While the detailed steps are described below, to summarize, when the tagged capacity manager 123 may determine that one process requests to write a duplicate of, or read the original data of the tag, the tagged capacity manager 123 may map the tag to the process so that the process can use the tag to access the original data without requiring a duplicate of the original data; when the tagged capacity manager 123 may determine that one process requests to modify (write extra data, crase, etc.) the original data of the tag, the tagged capacity manager may allocate local host memory page(s), copy the original data, and store the copied data in the allocated local host memory pages(s), and the tagged capacity manager 123 may map the local host memory pages(s) to the process so that the process can use the local host memory pages(s) to access the modified data. As such, the tagged capacity manager 123 may maintain a host mapping data structure, in which a process is mapped to a tag or local host memory page(s). In some cases, the modified data stored in the local host memory page(s) can be moved to a tagged capacity unit associated with a new tag, and the corresponding process can be mapped to the new tag.

FIG. 3B illustrate an example tag mapping data structure 310B (such as the tag mapping data structure 127) and an example host mapping data structure 330B (such as the host mapping data structure 227) that can be used to implement the COW operations associated with tagged capacity. The tag mapping data structure 310B may be the same as the tag mapping data structure 310A described above. The host mapping data structures 330B may include an item “physical address” and an item “host logical address.” The item “host logical address” indicates the process that is mapped to a tag or local host memory page(s). In the case of tag, the tag can be used to find in the example tag mapping data structure 310B the correspond DPA ranges, and thus, the process can access the DPA ranges to access the data. In the case of local host memory page(s), the process can access the physical address of the local host memory page(s) directly.

Now referring back to FIG. 2, responsive to receiving the request, from the process of the host system 220C, to access the original data of the tag, the tagged capacity manager 123 may determine whether the request attempts to modify the original data of the tag. The tagged capacity manager 123 may determine that the request does not attempt to modify the original data of the tag when the request is a read request of the tag, or a write request of a duplicate of the original data of the tag. In one example, the tagged capacity manager 123 may detect that the request is a write request for a duplicate of the original data. In another example, the tagged capacity manager 123 may detect that the request is to store a new file that is the same as an existing file of the tag. Responsive to determining that the host request does not attempt to modify the data, the tagged capacity manager 123 can map, in the host mapping data structure 227, the process of the host system 220C (e.g., process 1 in FIG. 3B) to the tag (e.g., Tag TC1 in FIG. 3B). When the process of the host system 220C requests to access the data, the tagged capacity manager 123 can use the tag to access the data. Therefore, the storage resources can be shared between a duplicate and an original copy of the data.

The tagged capacity manager 123 may determine that the request (e.g., received from process 3 in FIG. 3B) attempts to modify the original data of the tag when the request is a write request to modify (including erase) the original data of the tag. Responsive to determining that the host request attempts to modify the data, the tagged capacity manager 123 may allocate one or more memory pages of the local host memory 205, copy the data stored in the tagged capacity unit 231, and store the copied data in the memory pages of the local host memory 205. The tagged capacity manager 123 can map, in the host mapping data structure 227, the process of the host system 220C (e.g., process 3 in FIG. 3B) to the memory pages of local host memory 205 (e.g., Host Memory YYY1-YYY′1 in FIG. 3B). As such, any data modification request received for the existing tag can result in a copy being created and the process would no longer share the modified data with the other processes sharing the tag (e.g., process 1 in FIG. 3B cannot access the Host Memory YYY1-YYY′1 in FIG. 3B).

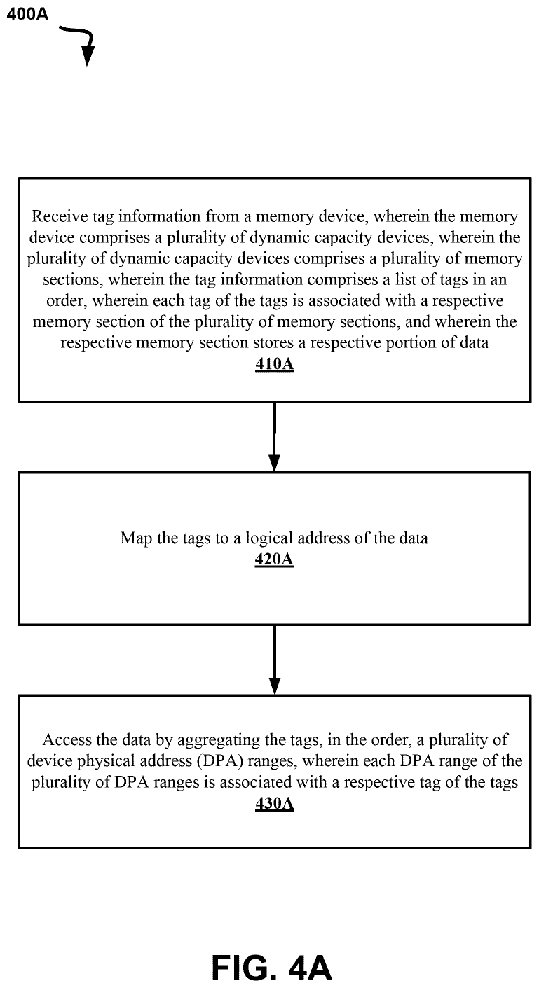

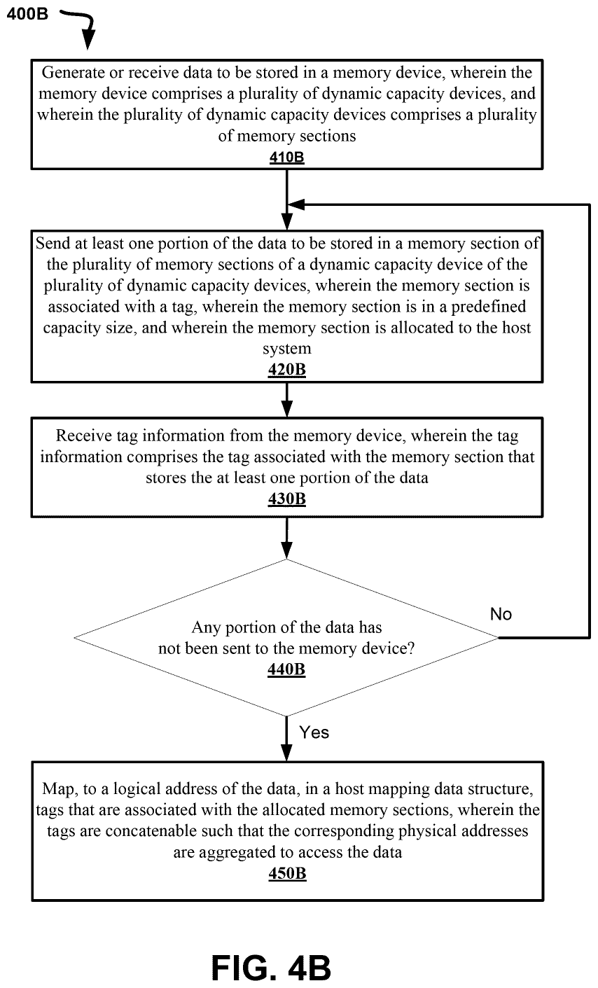

FIGS. 4A and 4B are flow diagrams of example methods 400A and 400B for using host-side aggregation operations associated with tagged capacity in a compute express link (CXL) memory device, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the methods 400A and 400B are performed by the tagged capacity manager 123 of FIG. 1 or FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 4A, the processing logic may send data to be stored in a memory device, and in response, at operation 410A, the processing logic receives tag information from a memory device, wherein the memory device (e.g., the CXL memory device 210) comprises multiple dynamic capacity devices (e.g., DCD 230A-230D), and multiple dynamic capacity devices (e.g., DCD 230A-230D) comprises multiple memory sections (e.g., memory sections 231A, 232A, 231B, 231C, 232C, 231D). The tag information comprises a set of tags in an order (e.g., tags TA1, TA2, TA3 in order in FIG. 3A), wherein each tag of the set of tags is associated with a respective memory section (e.g., tag T1 is associated with memory section 231A, tag T2 is associated with memory section 232A, tag T3 is associated with memory section 231B) of multiple memory sections, and wherein the respective memory section stores a respective portion of data. In one implementation, each tag of the tags is unique. In one implementation, a size of each memory section allocated to the host system and associated with a respective tag is immutable. In some implementations, the memory device comprises a compute express link (CXL) enabled memory device.

At operation 420A, the processing logic maps the tags (e.g., tags TA1, TA2, TA3 in FIG. 3A) to a logical address (e.g., YYY2-YYY′2 in FIG. 3A) of the data. In some implementations, the memory device stores, in a host mapping data structure, the tags and the logical address. In some implementations, the memory device generates an aggregation identifier (e.g., aggregation ID A1 in FIG. 3A) that collectively identifies the tags (e.g., tags TA1, TA2, TA3 in FIG. 3A) associated with the data. In some implementations, the memory device stores, in the host mapping data structure, the tags and the identifier.

At operation 430A, the processing logic accesses the data by aggregating, in the order of the set of tags, a plurality of device physical address (DPA) ranges (e.g., aggregating the DPA ranges XXX1-XXX′1, XXX2-XXX′2, XXX3-XXX′3 in the order of tag TA1, tag TA2, tag TA3 in FIG. 3A), wherein each DPA range of the plurality of DPA ranges is associated with a respective tag of the tags.

Referring to FIG. 4B, at operation 410B, the processing logic can generate or receive data to be stored in a memory device, wherein the memory device (e.g., the CXL memory device 210) comprises multiple dynamic capacity devices (e.g., DCD 230A-230D). In some implementations, multiple dynamic capacity devices comprises multiple memory sections (e.g., memory sections 231A, 232A, 231B, 231C, 232C, 231D), wherein each of multiple memory sections is associated with a respective one of a plurality of tags, and wherein each of the plurality of tags is unique. In some implementations, the memory device comprises a compute express link (CXL) enabled memory device.

At operation 420B, the processing logic sends at least one portion of the data to be stored in a memory section of multiple memory sections of a dynamic capacity device of multiple dynamic capacity devices, wherein the memory section is associated with a tag, wherein the memory section is in a predefined capacity size, and wherein the memory section is allocated to the host system. In some implementations, the processing logic sends a first portion of the data to be stored in a first memory section (e.g., taggable DC unit corresponding to 231A) of multiple dynamic capacity devices in the memory device, wherein the first memory section is associated with a first tag (e.g., tag TA1), wherein the first portion of the data is in a first predefined size. In some implementations, the first memory section is of the first predefined size, and the first memory section is allocated to the host system.

At operation 430B, the processing logic receives tag information from the memory device, wherein the tag information comprises a list of tags, wherein each tag of the tags is associated with a respective memory section that stores at least one portion of the data. In some implementations, the list of tags includes a first tag (e.g., tag TA1), wherein the first tag is associated with the first memory section that stores the first portion of the data.

At operation 440B, the processing logic determines whether any portion of the data has not been sent to the memory device for storing. For example, the processing logic may determine whether the total stored size of the data is less than the whole size of the data. In some implementations, the processing logic determines whether the first predefined size is less than the size of the data.

Responsive to determining that the first predefined size is not less than the size of the data, the processing logic may then, proceeding to operation 450B, map the first tag (e.g., tag TA1) to the logical address (e.g., YYY2-YYY′2 in FIG. 3A) of the data, and may store, in a host mapping data structure (e.g., 330A in FIG. 3A), the first tag and the logical address of the data. Responsive to determining that the first predefined size is less than the size of the data, the processing logic may then, proceeding to operation 420B, send a second portion of the data to be stored in a second memory section (e.g., taggable DC unit corresponding to 232A) of the plurality of dynamic capacity devices in the memory device, wherein the second memory section is associated with a second tag (e.g., tag TA2), wherein the second portion of the data is a second predefined size. In some implementations, the second memory section is of the second predefined capacity size, and the second memory section is allocated to the host system. The processing logic may then, proceeding to operation 430B, receive the tag information, wherein the list of tags includes a second tag (e.g., tag TA2) and the first tag (e.g., tag TA1), and proceeding to operation 440B, determine whether the total stored size of the data is less than the whole size of the data. At this point, the processing logic determines whether a sum of the first predefined size and the second predefined size is less than the size of the data.

Responsive to determining that the sum of the first predefined size and the second predefined size is not less than the size of the data, the processing logic may then, proceeding to operation 450B, map the first tag and second tag (e.g., tags TA1 and TA2) to the logical address (e.g., YYY2-YYY′2 in FIG. 3A) of the data, and may store, in a host mapping data structure (e.g., 330A in FIG. 3A), the first tag and the second tag and the logical address of the data. The first tag and the second tag are concatenable such that the corresponding memory sections can be aggregated to access the data.

Responsive to determine that the sum of the first predefined size and the second predefined size is less than the size of the data, the processing logic may then, proceeding to operation 420B, send a third portion of the data in a third predefined size. The processing logic may continue the loop of operations 420B, 430B, 440B until the processing logic determines, at operations 440B, that the total actually-stored size of the data is not less than the size of the data requested to be stored, that is, the allocated memory sections (tagged capacity) is large enough to store the data and there is no remaining data requested to be stored. The processing logic may then, at operation 450B, map, to the logical address of the data, all tags associated with the memory sections that have been allocated to the host system to store the data and may store, in a host mapping data structure, all tags and logical address. These tags are concatenable such that the corresponding memory sections can be aggregated to access the data. In some implementations, the processing logic may generate an aggregation identifier that collectively identifies tags associated with memory sections allocated to the host system to store the data, and store, in a host mapping data structure, the identifier with the tags.

In some implementations, a size of the memory section allocated to the host system and associated with a tag is immutable. For example, the first predefined size of the first memory section allocated to the host system and associated with the first tag is immutable, and the second predefined size of the second memory section allocated to the host system and associated with the second tag is immutable. In some implementations, each of the predefined sizes of the portion of the data may be the same. For example, the first predefined size equals the second predefined size.

In some implementations, the memory device controller or the fabric manager may allocate a memory section in the predefined size to the host system, and associate a tag with the memory section. In some implementations, the fabric manager may create the tag responsive to receiving the request for memory allocation from a node in an orchestrator cluster, wherein the node runs on the host system. In some implementations, the node generates the data. In some implementations, the memory device controller or the fabric manager may map the tag to the first memory section and the host system. In some implementations, one or more tags are shared by the host system and another host system.

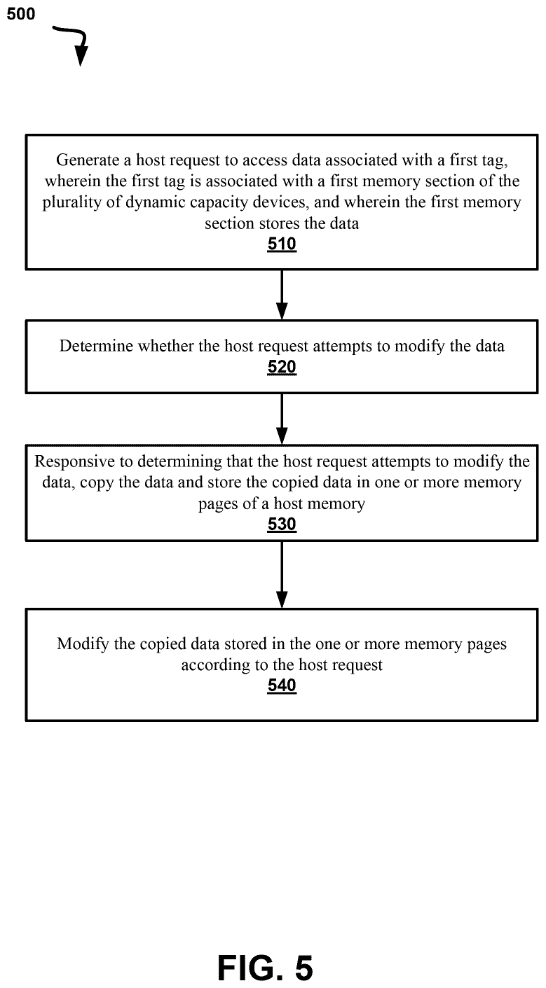

FIG. 5 is a flow diagram of an example method 500 for using host-side COW operations associated with tagged capacity in a compute express link (CXL) memory device, in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the tagged capacity manager 123 of FIG. 1 or FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, the processing logic can generate a host request to access data associated with a first tag (e.g., Tag TC1 in FIG. 3B), wherein the first tag is associated with a first memory section (e.g., taggable DC unit corresponding to 231C) of a plurality of dynamic capacity devices (e.g., DCD 230A-230D) of a memory device (e.g., the CXL memory device 210), and wherein the first memory section stores the data. In some implementations, each of the plurality of dynamic capacity devices comprises a plurality of memory sections (e.g., memory sections 231A, 232A, 231B, 231C, 232C, 231D), wherein each of the plurality of memory sections is associated with a respective one of a plurality of tags, and wherein each of the plurality of tags is unique. In some implementations, the memory device comprises a compute express link (CXL) enabled memory device.

In some implementations, the host request is received from a first process (e.g., process 3 in FIG. 3B) of a first host system (e.g., host ID H1 in FIG. 3B). In some implementations, the first tag is shared by the first process of the first host system and a second process (e.g., process 1 in FIG. 3B). In some implementations, the first process is a fork process of the second process. In some implementations, the capacity of the first memory section allocated to the first host system and associated with the first tag is immutable.

At operation 520, the processing logic can determine whether the host request attempts to modify the data. In some implementations, determining that the host request does not attempt to modify the data involves determining that the host request is a write request of a duplicate of the data or a read request. In some implementations, responsive to determining that the host request does not attempt to modify the data, the processing logic can map, in a data structure, the tag to a process that issues the host request. In some implementations, determining that the host request attempts to modify the data involves determining that the host request is a write request to modify the data.

At operation 530, responsive to determining that the host request attempts to modify the data, the processing logic can copy the data and store the copied data in one or more memory pages of a host memory (e.g., Host Memory YYY1-YYY′1 in FIG. 3B). In some implementations, the processing logic can allocate the one or more memory pages of the host memory according to the size of the data. At operation 540, the processing logic can modify the copied data stored in the one or more memory pages of the host memory according to the host request. In some implementations, the processing logic can map, in a data structure (e.g., 330B in FIG. 3B), the one or more memory pages of the host memory to a process that issues the host request. In some implementations, the one or more memory pages of the host memory is used as cache.

In some implementations, the processing logic can determine a second memory section (e.g., taggable DC unit corresponding to 232C or 231D) of the plurality of dynamic capacity devices and associate a second tag (e.g., Tag TC2 in FIG. 3B) with the second memory section, and the processing logic can store the modified data in the second memory section associated with the second tag. In some implementations, the processing logic can map the second tag to a process that issues the host request (e.g., the first process of the first host system) (e.g., process 3 in FIG. 3B). In some implementations, the second tag is shared by a process that issues the host request (e.g., the first process of the first host system) and another process. In some implementations, the capacity of the second memory section allocated to the first host system and associated with the second tag is immutable.

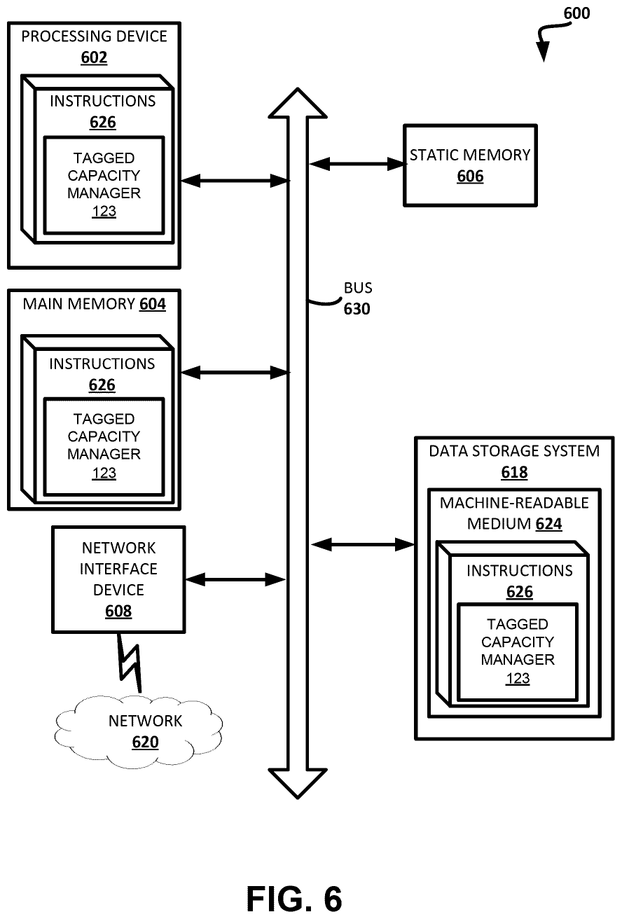

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the CXL memory device 110 of FIG. 1) or can be used to perform the operations of a controller (e.g., to execute an operating system to perform operations corresponding to the tagged capacity manager 123 of FIG. 1 or FIG. 2. In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the CXL memory device 110 of FIG. 1.

In one embodiment, the instructions 626 include instructions to implement functionality corresponding to an APL management component (e.g., the tagged capacity manager 123 of FIG. 1 or FIG. 2). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A host system comprising:
a memory; and
a processing device, operatively coupled with the memory, to perform operations comprising:
sending, to a memory device, data to be stored in the memory device, wherein the memory device comprises a plurality of dynamic capacity devices, wherein the plurality of dynamic capacity devices comprises a plurality of memory sections;
receiving, from the memory device, a response including tag information, wherein the tag information comprises a set of tags in an order, wherein each tag of the set of tags is associated with a respective memory section of the plurality of memory sections, and wherein the respective memory section stores a respective portion of the data;
mapping the tags to logical addresses of the data; and
accessing the data by aggregating, in the order of the set of tags, a plurality of device physical address (DPA) ranges, wherein each DPA range of the plurality of DPA ranges is associated with a respective tag of the tags.

2. The host system of claim 1, wherein sending the data to be stored in the memory device further comprises:
sending, to the memory device, a first portion of the data, wherein a first memory section of the plurality of memory sections stores the first portion of the data, wherein the first memory section is associated with a first tag, wherein the first portion of the data is in a first predefined size;
determining whether the first predefined size is less than a size of the data;
responsive determining that the first predefined size is less than the size of the data, sending, to the memory device, a second portion of the data, wherein a second memory section of the plurality of memory sections stores the second portion of the data, wherein the second memory section is associated with a second tag, wherein the second portion of the data is in a second predefined size; and
determining whether a sum of the first predefined size and the second predefined size is less than the size of the data;
wherein mapping the tags to the logical addresses of the data is performed responsive to determining that the sum of the first predefined size and the second predefined size is not less than the size of the data, wherein the set of tags includes the first tag and the second tag.

3. The host system of claim 2, wherein the first predefined size equals the second predefined size.

4. The host system of claim 1, wherein each tag of the tags is unique.

5. The host system of claim 1, wherein a size of each memory section allocated to the host system and associated with a respective tag is immutable.

6. The host system of claim 1, wherein the memory device is a compute express link (CXL) enabled memory device.

7. The host system of claim 1, wherein the operations further comprise:
storing, in a host mapping data structure, the tags and the logical addresses.

8. The host system of claim 1, wherein the operations further comprise:
generating an aggregation identifier that collectively identifies the tags associated with the data.

9. The host system of claim 8, wherein the operations further comprise:
storing, in a host mapping data structure, the tags, the logical addresses, and the aggregation identifier.

10. A method comprising:
sending, to a memory device, data to be stored in the memory device, wherein the memory device comprises a plurality of dynamic capacity devices, wherein the plurality of dynamic capacity devices comprises a plurality of memory sections;
receiving, by a host device, from the memory device, a response including tag information, wherein the tag information comprises a set of tags in an order, wherein each tag of the set of tags is associated with a respective memory section of the plurality of memory sections, and wherein the respective memory section stores a respective portion of the data;
mapping the tags to logical addresses of the data; and
accessing the data by aggregating, in the order of the set of tags, a plurality of device physical address (DPA) ranges, wherein each DPA range of the plurality of DPA ranges is associated with a respective tag of the tags.

11. The method of claim 10, wherein sending the data to be stored in the memory device further comprises:
sending, to the memory device, a first portion of the data, wherein a first memory section of the plurality of memory sections stores the first portion of the data, wherein the first memory section is associated with a first tag, wherein the first portion of the data is in a first predefined size;
determining whether the first predefined size is less than a size of the data;
responsive determining that the first predefined size is less than the size of the data, sending, to the memory device, a second portion of the data, wherein a second memory section of the plurality of memory sections stores the second portion of the data, wherein the second memory section is associated with a second tag, wherein the second portion of the data is in a second predefined size; and
determining whether a sum of the first predefined size and the second predefined size is less than the size of the data;
wherein mapping the tags to the logical addresses of the data is performed responsive to determining that the sum of the first predefined size and the second predefined size is not less than the size of the data, wherein the set of tags includes the first tag and the second tag.

12. The method of claim 11, wherein the first predefined size equals the second predefined size.

13. The method of claim 10, wherein each tag of the tags is unique.

14. The method of claim 10, wherein a size of each memory section allocated to the host system and associated with a respective tag is immutable.

15. The method of claim 10, wherein the memory device is a compute express link (CXL) enabled memory device.

16. A non-transitory computer-readable storage medium comprising instructions that, when executed by a processing device, cause the processing device to perform operations comprising:
sending, to a memory device, data to be stored in the memory device, wherein the memory device comprises a plurality of dynamic capacity devices, wherein the plurality of dynamic capacity devices comprises a plurality of memory sections;
receiving, from the memory device, a response including tag information, wherein the tag information comprises a set of tags in an order, wherein each tag of the set of tags is associated with a respective memory section of the plurality of memory sections, and wherein the respective memory section stores a respective portion of the data;
mapping the tags to logical addresses of the data; and
accessing the data by aggregating, in the order of the set of tags, a plurality of device physical address (DPA) ranges, wherein each DPA range of the plurality of DPA ranges is associated with a respective tag of the tags.

17. The non-transitory computer-readable storage medium of claim 16, wherein sending the data to be stored in the memory device further comprises:
sending, to the memory device, a first portion of the data, wherein a first memory section of the plurality of memory sections stores the first portion of the data, wherein the first memory section is associated with a first tag, wherein the first portion of the data is in a first predefined size;
determining whether the first predefined size is less than a size of the data;
responsive determining that the first predefined size is less than the size of the data, sending, to the memory device, a second portion of the data, wherein a second memory section of the plurality of memory sections stores the second portion of the data, wherein the second memory section is associated with a second tag, wherein the second portion of the data is in a second predefined size; and
determining whether a sum of the first predefined size and the second predefined size is less than the size of the data;
wherein mapping the tags to the logical addresses of the data is performed responsive to determining that the sum of the first predefined size and the second predefined size is not less than the size of the data, wherein the set of tags includes the first tag and the second tag.

18. The non-transitory computer-readable storage medium of claim 17, wherein the first predefined size equals the second predefined size.

19. The non-transitory computer-readable storage medium of claim 16, wherein each tag of the tags is unique.

20. The non-transitory computer-readable storage medium of claim 16, wherein a size of each memory section allocated to the host system and associated with a respective tag is immutable.
